(19) United States
(12) Patent Application Publication
(10) Pub. No.: US 2024/0184613 A1
(43) Pub. Date: Jun. 6, 2024

(54) SYSTEMS AND METHODS FOR TRAINING SYSTEMS TO DETECT OFFENSIVE CYBER OPERATIONS

(71) Applicant: Aries Security, LLC, Wilmington, DE (US)

(72) Inventors: Brian Markus, El Dorado Hills, CA (US); Timothy Bulger, Austin, TX (US); Arlen Haftevani, Los Angeles, CA (US); Jeff Rosowski, Las Vegas, NV (US)

(73) Assignee: Aries Security, LLC, Wilmington, DE (US)

(21) Appl. No.: 18/285,112

(22) PCT Filed: Apr. 1, 2022
(86) PCT No.: PCT/US2022/023042

§ 371 Date: Sep. 29, 2023

Related U.S. Application Data
(60) Provisional application No. 63/170,209, filed on Apr. 2, 2021.

(51) Int. Cl. G06F 9/455

(52) U.S. Cl. CPC G06F 9/45558; G06F 2009/45587; G06F 2009/45591

(57) ABSTRACT

A method for providing dynamic virtual machines includes generating a virtual machine implementing one or more software vulnerabilities, assigning the virtual machine to a client computing system, rendering a graphical user interface for display on a display device of the client computing system, wherein the graphical user interface is configured to display parameters of the virtual machine and interface tools to receive input from a user during simulation of the virtual machine, monitoring inputs from the user during the simulation of the virtual machine on the client computing system, and in response to monitoring the inputs from the user, verifying a correctness of an identification of the one or more software vulnerabilities from the inputs.

### CROSS REFERENCE TO RELATED APPLICATION

This application claims the benefit of U.S. Provisional Patent Application Ser. No. 63/170,209 filed on Apr. 2, 2021 which is incorporated by reference in its entirety.

### TECHNICAL FIELD

The present disclosure relates to systems and methods for dynamic creation of virtual machines for computing system compromise identification and, more particularly, systems and methods for dynamically generating simulated virtual machines, computer system test parameters and solutions.

### BACKGROUND

Computing systems may be vulnerable to malicious manipulation caused by third parties, allowing for exploitation of weaknesses within the computing system or software, in turn allowing compromise of the computing system or software. Accordingly, a need exists for systems that train users and/or computer systems (e.g., machine learning systems) to dynamically identify and remedy malicious manipulations to simulated application and network services.

### SUMMARY

In one embodiment, a method for providing dynamic virtual machines includes generating a virtual machine implementing one or more software vulnerabilities, assigning the virtual machine to a client computing system, rendering a graphical user interface for display on a display device of the client computing system, wherein the graphical user interface is configured to display parameters of the virtual machine and interface tools to receive input from a user during simulation of the virtual machine, monitoring inputs from the user during the simulation of the virtual machine on the client computing system, and in response to monitoring the inputs from the user, verifying a correctness of an identification of the one or more software vulnerabilities from the inputs.

In another embodiment, a system for providing dynamic virtual machines is disclosed. The system includes an administrative computing device comprising a processor, and a non-transitory computer-readable medium; and a machine-readable instruction set stored in the non-transitory computer readable memory of the administrative computing device that causes the system to perform at least the following when executed by the processor: generate a virtual machine implementing one or more software vulnerabilities, assign the virtual machine to a client computing system, render a graphical user interface for display on a display device of the client computing system, where the graphical user interface is configured to display parameters of the virtual machine and interface tools to receive input from a user during simulation of the virtual machine, monitor inputs from the user during the simulation of the virtual machine on the client computing system, and in response to monitoring the inputs from the user, verify a correctness of an identification of the one or more software vulnerabilities from the inputs.

In another embodiment, a computer program for providing dynamic virtual machines comprising instructions which, when the computer program is executed by a computer, cause the computer to carry out steps including generating a virtual machine implementing one or more software vulnerabilities, assigning the virtual machine to a client computing system, rendering a graphical user interface for display on a display device of the client computing system, wherein the graphical user interface is configured to display parameters of the virtual machine and interface tools to receive input from a user during simulation of the virtual machine, monitoring inputs from the user during the simulation of the virtual machine on the client computing system, and in response to monitoring the inputs from the user, verifying a correctness of an identification of the one or more software vulnerabilities from the inputs.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative system for generating virtual machines based on randomized parameters, and training a user or a computer system to identify predefined software vulnerabilities using a plurality of client computing systems according to one or more embodiments shown and described herein;

FIG. 2 schematically depicts an illustrative screen shot displayed by an interface on a client computing device for a simulation session according to one or more embodiments shown and described herein;

FIG. 3 schematically depicts an illustrative screen shot displayed by an interface on a client computing device for a simulation session including dynamically generated parameters for a virtual machine according to one or more embodiments shown and described herein;

FIG. 4 schematically depicts an illustrative screen shot displayed by an interface on a client computing device for a syntax challenge system for a first syntax according to one or more embodiments shown and described herein;

FIG. 5 schematically depicts an illustrative screen shot displayed by an interface on a client computing device for a syntax challenge system for a second syntax according to one or more embodiments shown and described herein;

FIG. 6 depicts schematically depicts an illustrative screen shot displayed by an interface on a client computing device for a matching system according to one or more embodiments shown and described herein; and

FIG. 7 depicts an illustrative flow diagram of a method for providing a virtual machine implementing software vulnerabilities to train users and/or computer systems to detect and address the software vulnerabilities according to one or more embodiments shown and described herein.

### DETAILED DESCRIPTION

Embodiments include a client computing system and an administrative computing system. The administrative computing system dynamically creates virtual machines and assigns a virtual machine to the client computing system. The administrative computing system identifies software vulnerabilities. The client computing system receives the virtual machine and attempts to identify the software vulnerabilities.

Referring to the figures, embodiments of the present disclosure are generally directed to devices, systems, and methods for generating virtual machines based on randomized parameters, and training a user or a computer system to identify predefined software vulnerabilities using a plurality of client computing systems. Virtual machines may be containerized such that virtual processors and services may be employed on or within computing environments and may act as if they are physical machines. In embodiments, an administrative computing system is communicatively coupled to the plurality of client computing systems, and the administrative computing system includes an orchestration engine that generates dynamic parameters for a virtual engine. The administrative computing system assigns virtual engines to each of the client computing systems and deploys virtual computing resources according the virtual machines. The virtual machines may each include machine-readable instructions that are executable by a virtual processor, and each of the machine-readable instructions may include one or more software vulnerabilities intentionally encoded therein. The administrative computing system may dynamically determine the one or more software vulnerabilities as virtual machines are created on one or more virtual machines it deploys. This may allow the administrative computing system to generate virtual machines having varying parameters and varying software vulnerabilities. Accordingly, the administrative computing system may provide each client computing device with one or more differing virtual machines having differing software vulnerabilities.

Each client computing system may render one or more graphical user interfaces via one or more display devices. The graphical user interfaces can display parameters of the virtual machine. The graphical user interfaces may further provide interface tools to receive input from users during simulation of virtual machines. Users of each of the client computing systems (or the client computing system itself in embodiments where the client computing system is being trained) may evaluate their respective virtual machine and attempt to identify predefined software vulnerabilities specific to the virtual machine. The client computing system may receive an identification of the software vulnerabilities and may verify the correctness of the identification of the software vulnerabilities.

Further described herein are embodiments of the present disclosure generally directed to devices, systems, and methods for a syntax challenge system configured to dynamically build syntax problems based on a given software tool or programing language. The syntax problem may include dynamically selected parameters. The syntax challenge system further calculates solutions in response to the dynamically built syntax problem. The syntax challenge system may provide a user with a graphical user interface that may be populated with the dynamically selected parameters. The graphical user interface further provides interface tools that accept input to receive a user generated (or the client computing system itself in embodiments where the client computing system is being trained) solution. The syntax challenge system verify the user generated solution.

Accordingly, the syntax challenge system can train or test a user (or the client computing system itself in embodiments where the client computing system is being trained) on the use of proper syntax for a given tool. The syntax challenge system provides a randomized combination of requirements to a user (e.g., the question for the user to solve). The randomized requirements are based on the given tool (tcpdump, Snort®, etc.). The syntax challenge system also provides an interface for a user to enter an answer. The interface can include graphical interface tools (e.g., buttons, drop down menus, text boxes, etc.) that allow and enable a user to configure and build a solution or answer to the syntax problem. The interface tools may vary depending on the given intrusion detection/prevention tool.

Additionally described are embodiments of the present disclosure generally directed to devices, systems, and methods for a matching system. The match system may dynamically select a plurality of related items. The plurality of related items may be displayed, via a display device, on a graphical user interface. In examples, the graphical user interface includes a plurality of columns, wherein columns relate to a general category (e.g., protocols, ports, etc.). For instance, a first column may include a plurality of different computing protocols and a second column may include a plurality of different ports. Each of the plurality of different protocols may be correlated to one or more of the plurality of different ports. A user (or the client computing system itself in embodiments where the client computing system is being trained) may select matches of ports and protocols. The match system may verify the selected matches to determine whether the user has provided correct matches. In embodiments, the match system may randomize selection of the related items, order of items, or the like to reduce a user's ability to cheat and/or otherwise circumvent various training objectives and processes.

As described herein, the administrative computing system may monitor the client computing system, track user progress, track results of identifications, and provide administrators with reports regarding a client computing system. In response to verification of the correctness of the identification, matches, or other input, a simulation may be completed and/or another simulation of a different virtual machine may be initiated.

Upon completion of or during a simulation or testing session, the administrative computing system may generate and report a score for each client computing system of the plurality of computing systems. Subsequently, the administrative computing system may rank and generate a report indicating the ranking of each client computing system of the client computing systems.

Accordingly, the offensive cyber operations training system enables users and/or systems to improve their ability to identify and correct various computing system and network issues that may arise due to malicious third party actions, such as memory corruption issues, memory vulnerability issues, memory disclosure issues, information leakage issues, logic vulnerability issues, cryptographic issues, and/or the like.

As used herein, the term “software vulnerabilities” or “software vulnerability” refers to an error, flaw, fault, and/or vulnerability that is associated with at least one of an application service and/or a network of a computing system. As used herein, the term “predefined software vulnerability” refers to an error, flaw, fault, and/or vulnerability that is selected from a predetermined set of errors, flaws, faults, and/or vulnerabilities associated with at least one of an application service and/or a network of a computing system.

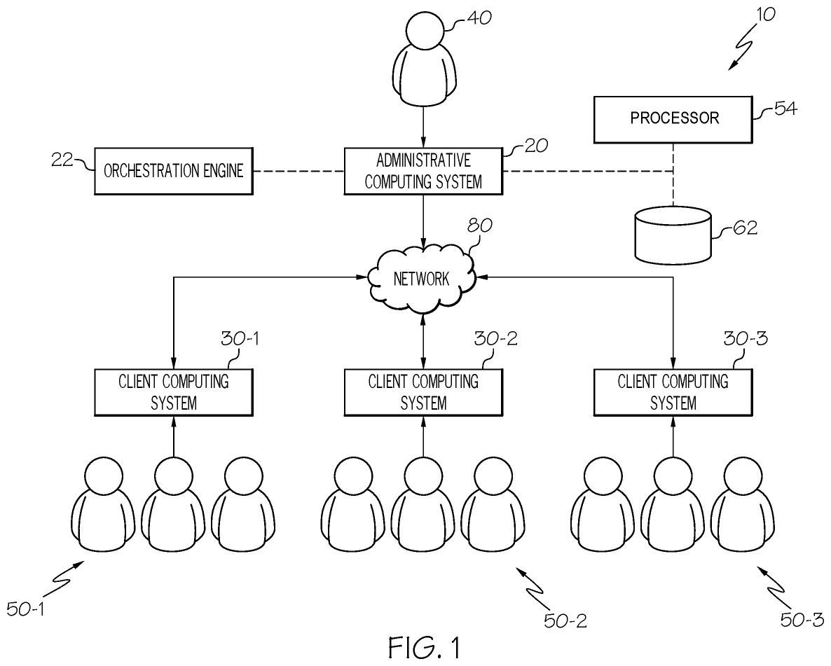

Now referring to FIG. 1, a system 10 for generating virtual machines based on randomized parameters, and training a user or a computer system to identify predefined software vulnerabilities using a plurality of client computing systems is schematically illustrated. In embodiments, the system 10 includes an administrative computing system 20, a first client computing system 30-1, a second client computing system 30-2, a third client computing system 30-3 (collectively referred to as client computing systems 30). While three client computing systems 30-1, 30-2, 30-3 are illustrated, it should be understood that the system 10 may include any number of client computing systems 30 in other embodiments. The client computing systems 30 and the administrative computing system may be communicatively coupled via network 80.

As shown in FIG. 1, the administrative computing system 20 may be operated and controlled by an administrator 40. Furthermore, the first client computing system 30-1 may be operated and controlled by users 50-1, the second client computing system 30-2 may be operated and controlled by users 50-2, and the third client computing system 30-3 may be operated and controlled by users 50-3. While the system 10 illustrates the client computing systems 30 being operated and controlled by the users 50-1, 50-2, 50-3 (collectively referred to as users 50), it should be understood that the operation and control of the client computing systems 30 may be partially or entirely executed by the client computing systems 30 without any interaction with a user. As a non-limiting example, the client computing systems 30 may be artificial intelligence (AI) computing systems that execute the functionality described herein using one or more machine-learning and/or one or more deep-learning algorithms and without input from the users 50.

In embodiments, the administrative computing system 20 may include or be coupled with one or more processors 54 and one or more non-transitory computer-readable mediums 62. The one or more processors 54, each of which may be a computer processing unit (CPU), may receive and execute machine-readable instructions stored in the one or more non-transitory computer-readable mediums 62. As a non-limiting example, the one or more processors 54 may be one of a shared processor circuit, dedicated processor circuit, or group processor circuit. The term “shared processor circuit” refers to a single processor circuit that executes some or all machine-readable instructions from the multiple modules. The term “group processor circuit” refers to a processor circuit that, in combination with additional processor circuits, executes some or all machine-executable instructions from the multiple modules of one or more non-transitory computer-readable mediums. References to multiple processor circuits encompass multiple processor circuits on discrete dies, multiple processor circuits on a single die, multiple cores of a single processor circuit, multiple threads of a single processor circuit, or a combination of the above.

The one or more non-transitory computer-readable mediums 62 are communicatively coupled to the one or more processors 54. As a non-limiting example, the one or more non-transitory computer-readable mediums 62 may be one of a shared memory circuit, dedicated memory circuit, or group memory circuit. The term “shared memory circuit” refers to a single memory circuit that stores some or all machine-readable instructions from multiple modules, which are described below in further detail. The term “group memory circuit” refers to a memory circuit that, in combination with additional memories, stores some or all machine-readable instructions from the multiple modules. Non-limiting examples of the one or more non-transitory computer-readable mediums 62 include random access memory (including SRAM, DRAM, and/or other types of random access memory), read-only memory (ROM), flash memory, registers, compact discs (CD), digital versatile discs (DVD), and/or other types of storage components.

Still referring to FIG. 1, the administrative computing system 20 may include or be coupled to an orchestration engine 22. The orchestration engine 22 may include computer readable instructions that may be stored in the one or more non-transitory computer-readable mediums 62, and may be executed by the one or more processors 54. In an example, the orchestration engine 22 may build virtual machines that provide computing resources to each of the client computing systems 30. The virtual machines may each include machine-readable instructions that are executable by a virtual processor.

In embodiments, the orchestration engine 22 may dynamically select parameters for a virtual machine such that the configuration of the plurality of virtual machines are varied. Varying the configurations of the virtual machines may ensure that virtual machines are unique (or semi-unique, such as unique within a given set of possibilities). This may allow the administrative computing system 20 to provide uniquely configured virtual machines to each of the client computing systems 30.

The orchestration engine 22 may dynamically select the parameters from a database of predetermined parameters (e.g., such as stored in one or more non-transitory computer-readable mediums 62). The parameters may comprise computing addresses (e.g., Internet Protocol (“IP”) address), port configurations, memory requirements, CPU requirements, or other information relating to operation requirements of a virtual machine. In examples, the predetermined parameters may include, for example, IP addresses that are not otherwise addressable such that client computing systems 30 do not attempt to connect to third party computing systems.

The orchestration engine 22 may dynamically select the parameters for a plurality of virtual machines according to a selection process. The selection process may utilize randomization algorithms (including semi-randomization algorithms), weighting-algorithm, machine-learning and/or deep-learning algorithms (e.g., AI), or other algorithms to dynamically select parameters. In some embodiments, the orchestration engine 22 may select parameters for virtual machines based on the client computing systems 30, the users 50, or a history associated with the client computing systems 30 or the users 50. As described herein, the dynamic selection allows for creation of virtual machines with varying parameters. Moreover, the dynamic selection may allow for creation of virtual machines in response to requests received from client computing systems 30 as described in more detail below.

In embodiments, the orchestration engine 22 may further determine software vulnerabilities for the plurality of virtual machines. The vulnerabilities for the plurality of virtual machines may be determined by the orchestration engine 22 in response to the dynamic selection of the parameters. As an example, the orchestration engine 22 may identify a location in memory of the virtual machine based on one or more of the dynamically selected parameters. The orchestration engine 22 may place a token at the location in memory to represent the software vulnerabilities. In a simulation where user 50 seeks to locate the software vulnerabilities, the orchestration engine 22 may select the marker or token from a predetermined tokens stored in, for example, the one or more non-transitory computer-readable mediums 62. The predetermined token may include a pass phrase comprising an alphanumerical string. The alphanumerical string may comprise, for instance, predetermined combinations of words of phrases.

The orchestration engine 22 generates the virtual machines such that the client computing systems 30 (and/or the users 50) implement the virtual machines as if they are physical machines. For instance, the virtual machines may be connected to the client computing systems through direct IP access, without proxy or other intermediary systems or services. As such, the client computing systems 30 and/or the users 50 are provided with a realistic experience and may be unaware that the virtual machines are not individual, physical machines.

Still referring to FIG. 1, the orchestration engine 22 may conduct load balancing of the administrative computing system 20 based on demands from client computing systems 30. The load balancing may include monitoring and managing CPU usage, storage, location, computing services, or other operating parameters such that the administrative computing system 20 may provide services to the client computing systems 30. The orchestration engine 22 further determines whether requests from client computing systems 30 can be created at a given time based on available recourses of the administrative computing system 20. In some instance, the orchestration engine 22 may modify or reallocate CPU usage of the administrative computing system 20 based on current or anticipated demands from the client computing systems.

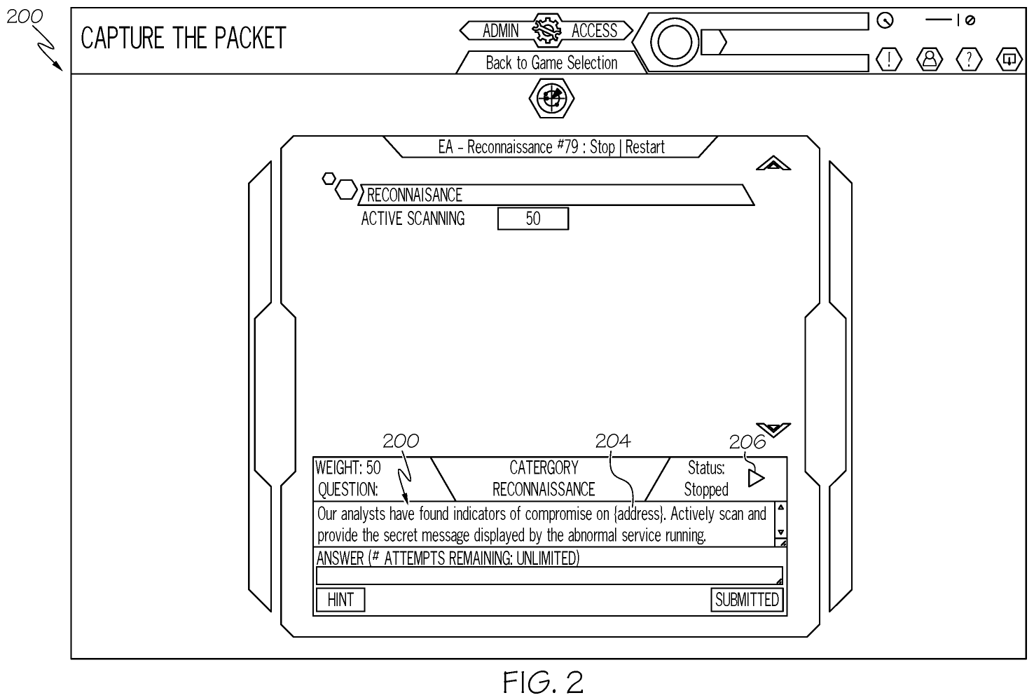

In various embodiments, the orchestration engine 22 may assign varying virtual machines to simulation sessions deployed to each of the client computing systems 30 using the administrative computing system 20. As a non-limiting example and as described below in further detail with reference to FIGS. 2-5, the administrator 40 may assign each of the users 50 to a particular client computing system 30, dynamically define software vulnerabilities to be include within the virtual machines, and define a length of the simulation session.

As described below in further detail with reference to FIGS. 2-5, during a simulation session, the users 50 of each of the client computing systems 30 (or the client computing systems 30 without any user interaction) may evaluate their respective deployed virtual machines, locate and identify or correct the predefined software vulnerabilities, and submit the predefined software vulnerabilities to the administrative computing system 20 for verification. In response to the administrative computing system 20 verifying that the users 50 of the corresponding client computing system 30 (or the respective client computing system 30 without any user interaction) have properly corrected or identified the predefined software vulnerabilities, the administrative computing system 20 increases a score associated with the corresponding client computing systems 30.

The client computing systems 30 may include or be coupled with one or more processors and one or more non-transitory computer-readable mediums. Moreover, the client computing systems 30 may include network interface hardware that may include any wired or wireless networking hardware for communication via the network 80, including an antenna, a modem, a LAN port, a wireless fidelity (Wi-Fi) card, a WiMax card, a long term evolution (LTE) card, a ZigBee card, a Bluetooth chip, a USB card, mobile communications hardware, and/or other hardware for communicating with other networks and/or devices. The client computing systems 30 may further include user interface devices, such as a keyboard, mouse (e.g., pointing device), joystick, remote controller, gaming controller, touch screen, stylus, display devices (e.g., computer monitors, projectors, televisions screens, etc.), or other human input/output devices.

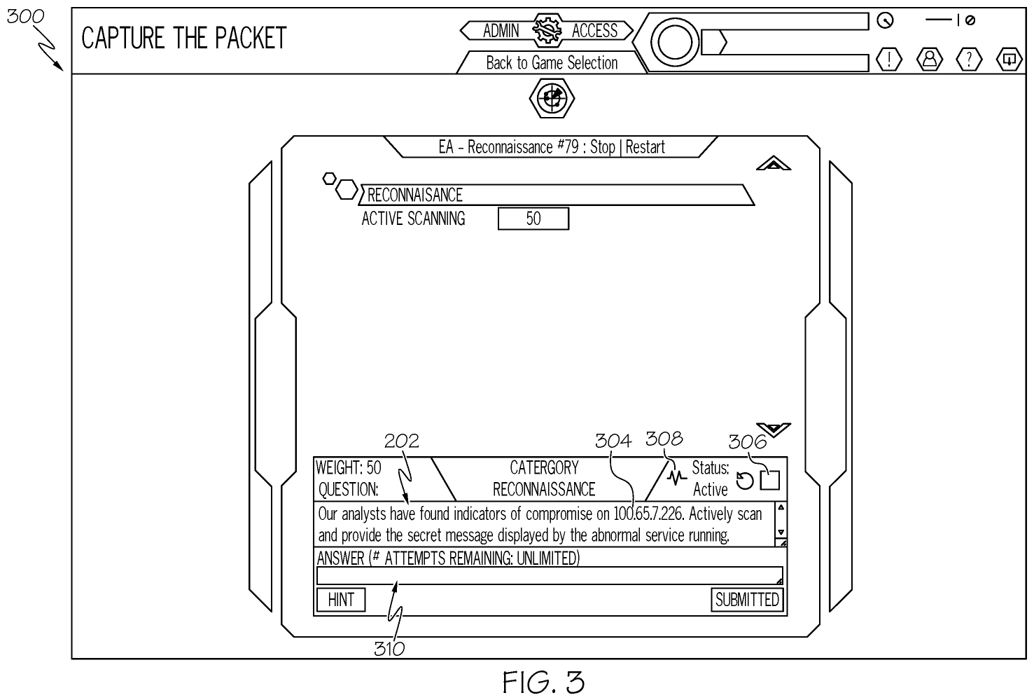

Turning to FIGS. 2-3, while referencing FIG. 1, the client computing systems 30 may render interfaces 200 and 300 via display devices. Interface 200 includes a graphical user interface tools that may allow a user 50 to request generation of a virtual machine for a simulation session. As depicted, the interface 200 may include a problem identification window 202. The problem identification window 202 includes a prompt or instructions for a user and an identification 204 of parameters to be dynamically determined. When a user 50 is ready to begin a simulation session, the user may select an activation tool 206 to begin training of the user (or the client computing system itself in embodiments where the client computing system is being trained).

As shown in FIG. 3, the interface 300 has been updated or otherwise modified from the interface 200 of FIG. 2 in response to selection of the activation tool 206 and input provided from the administrative computing system 20. For instance, the administrative computing system 20 may dynamically build a virtual machine in response to receiving a request from for activation from the client computing system 30. As described herein, the administrative computing system 20 (e.g., via the orchestration engine 22) selects or calculates parameters for the virtual machine such that the virtual machine includes randomized or semi-randomized parameters. This allows for dynamic creation of virtual machines to enable training and prevent answer sharing or copying by users 50.

Still referring to FIGS. 1-3, the interface 300 includes identification window 202 including one or more dynamically identified parameters 304 for a virtual machine assigned to the client computing system 30. The interface 300 may further include a live service identifier 308 that identifies that the client computing system 30 is at least one of the client computing systems 30 assigned to a virtual machine, receiving services from the administrative computing system 20, or deploying a simulation session. The interface 300 may further include simulation control tools 306 that may allow a user to terminate a simulation, pause a simulation, request a new dynamically created virtual machine, or otherwise modify a simulation session.

In embodiments, a user 50 may receive the interface 300 via a client computing system 30 and may interact with a display device to perform a simulation session. By way of example, the client computing system 30 provides the user with the dynamically identified parameters 304 within the identification window 202. The identification window 202 provides a prompt or problem for the user 50 to solve. Once the user receives the dynamically identified parameters 304, the user may execute appropriate steps via the client computing device to attempt to solve the problem. In this example, the solution comprises a token at a location in memory to represent a software vulnerability. As described herein, the token is located at a dynamically identified location and include a dynamic alphanumerical string. In simulation, the user 50 seeks to locate the token and provides the token in answer box 310. The administrative computing system 20 may then verify the users answer to determine whether it matches the dynamically generated token. In embodiments where the client computing system 30 itself is being trained, the client computing system 30 may or may not provide answers via the interface 300.

Upon completion of the simulation session, the administrative computing system 20 may generate and report a score for each of the client computing systems 30. In some embodiments, the administrative computing system 20 may store parameters for virtual machines, tokens, or the like in memory (e.g., the one or more non-transitory computer-readable mediums 62). Future dynamically created virtual machines may be cross-referenced to the stored parameters for virtual machines and/or tokens previously utilized to ensure that a user 50 or subset of users 50 (e.g., users with in a common organization, users at a common location, etc.) do not receive the same virtual parameters for virtual machines and/or tokens. It is noted, however, that the likelihood of generating identical parameters for virtual machines and/or tokens may be very low.

Referring to FIGS. 1 and 4-5, the client computing systems 30 may render interfaces 400 and 500 via display devices for a syntax challenge system. The syntax challenge system may be deployed as part of or separate from other embodiments described herein. In some embodiments, the client computing systems 30 may render interfaces 400 and 500 based on dynamically identified parameters from the administrative computing system 20 or based on local permutations or installations of the syntax challenge system. At least for simplicity of explanation, embodiments may be described as one of the administrative computing system 20 or the client computing systems 30 executing performing computing operations. It should be understood, however, that one or more of the administrative computing system 20 or the client computing systems 30 may execute operations.

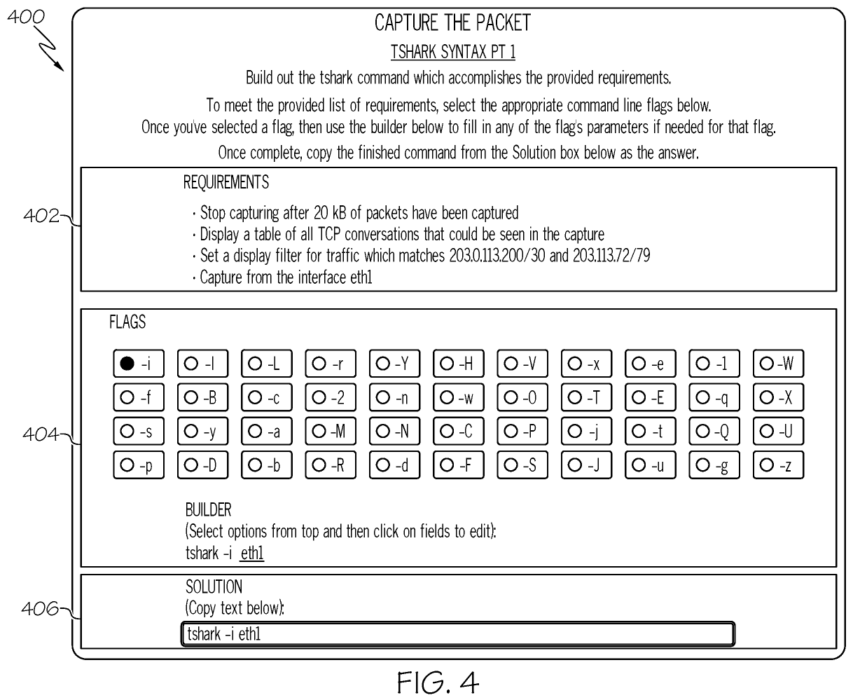

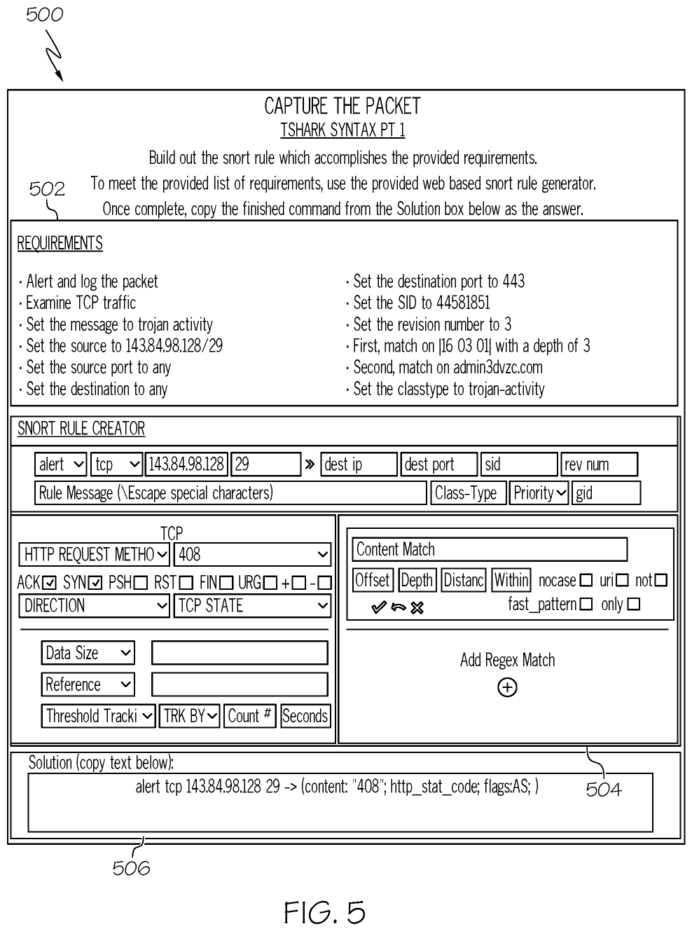

According to embodiments, the client computing system 30 may include syntax challenge system logic comprising computer executable instructions (e.g., stored in one or more non-transitory computer-readable mediums 62) that can be executed by one or more processors 54. The client computing system 30 may execute the syntax challenge system logic to dynamically generate parameters for a virtual machine, where the parameters relate to syntax of a computing tool (e.g., tcpdump, tshark, Snort®, etc.) or other appropriate tool. FIG. 4 depicts an example of tshark syntax and FIG. 5 depicts an example of Snort® syntax. It is noted that the system syntax challenge system is not limited to cyber security related tools and can be used for training of syntax of commands/applications in any field of computing.

The parameters may be selected from a predetermine plurality of parameters (e.g., stored in one or more non-transitory computer-readable mediums 62) based on a desired syntax to be utilized. The selection process may utilize randomization algorithms (including semi-randomization algorithms), weighting-algorithm, machine-learning and/or deep-learning algorithms (e.g., AI), or other algorithms to dynamically select parameters. In some embodiments, the orchestration engine 22 may select parameters for virtual machines based on the client computing systems 30, the users 50, or a history associated with the client computing systems 30 or the users 50. As described herein, the dynamic selection allows for creation of virtual machines with varying parameters. Moreover, the dynamic selection may allow for creation of virtual machines in response to requests received from client computing systems 30 as described in more detail below.

Still referring to FIGS. 4-5, the interfaces 400 and 500 may respectively include a parameter identification window 402, 502 for displaying dynamically selected parameters, a solution creation window 404 for receiving user input to solve a problem defined by the parameters, and a solution input window 406, 506 for receiving user input regarding a user 50 generated solution. The client computing system 30 may receive user input and the administrative computing system 20 may verify the user 50 solution.

As described herein, the syntax challenge system may dynamically build syntax problems based on a given software tool or programing language. The syntax problem may include dynamically selected parameters. The syntax challenge system further calculates solutions in response to the dynamically built syntax problem. The syntax challenge system may provide a user with a graphical user interface that may be populated with the dynamically selected parameters. The graphical user interface further provides interface tools that except input to receive a user generated (or the client computing system itself in embodiments where the client computing system is being trained) solution. The syntax challenge system verify the user generated solution.

Accordingly, the syntax challenge system can train or test a user (or the client computing system itself in embodiments where the client computing system is being trained) on the use of proper syntax for a given tool. The syntax challenge system provides a randomized combination of requirements to a user (e.g., the question for the user to solve). The randomized requirements are based on the given intrusion detection/prevention tool (tcpdump, Snort®, etc.). The syntax challenge system also provides an interface for a user to enter an answer. The interface can include graphical interface tools (e.g., buttons, drop down menus, text boxes, etc.) that allow a user to configure and build a solution or answer to the syntax problem. The interface tools may vary depending on the given intrusion detection/prevention tool.

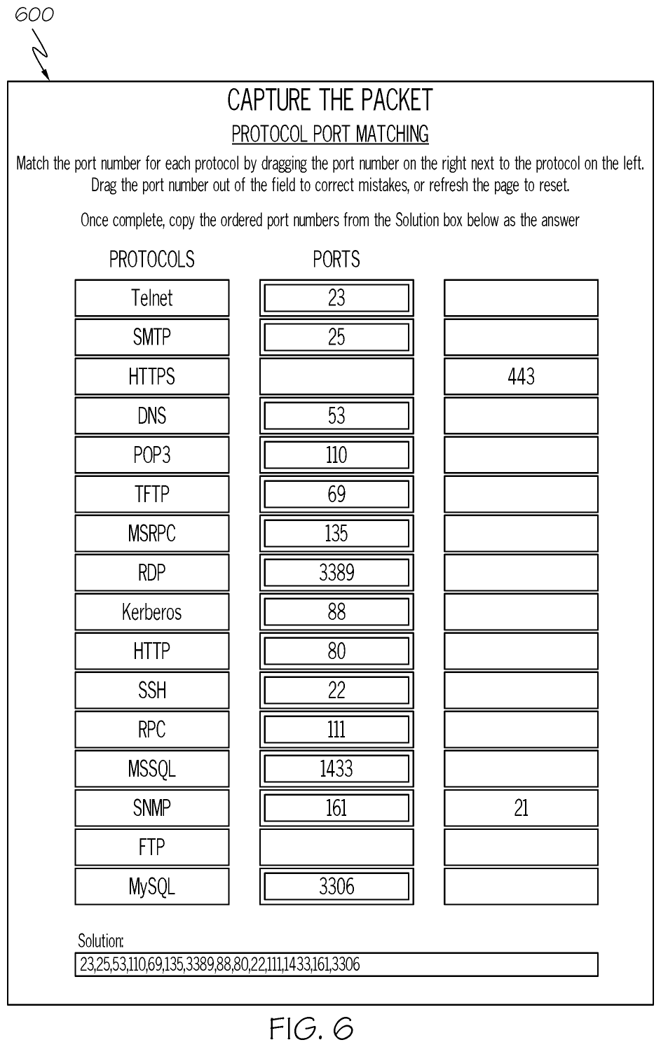

Referring now to FIGS. 1 and 6, there is an interface 600 for a match system that may be deployed by the client computing system 30, the administrative computing system 20, or both. The match system may dynamically select a plurality of related items. The plurality of related items may be displayed, via a display device, on a graphical user interface. In examples, the graphical user interface includes a plurality of columns, wherein columns relate to a general category (e.g., protocols, ports, etc.). For instance, a first column may include a plurality of different computing protocols and a second column may include a plurality of different ports. Each of the plurality of different protocols may be correlated to one or more of the plurality of different ports. A user (or the client computing system itself in embodiments where the client computing system is being trained) may select matches of ports and protocols. The match system may verify the selected matches to determine whether the user has provided correct matches. In embodiments, the match system may randomize selection of the related items, order of items, or the like to reduce a user's ability to cheat and/or otherwise circumvent certain processes and/or requirements.

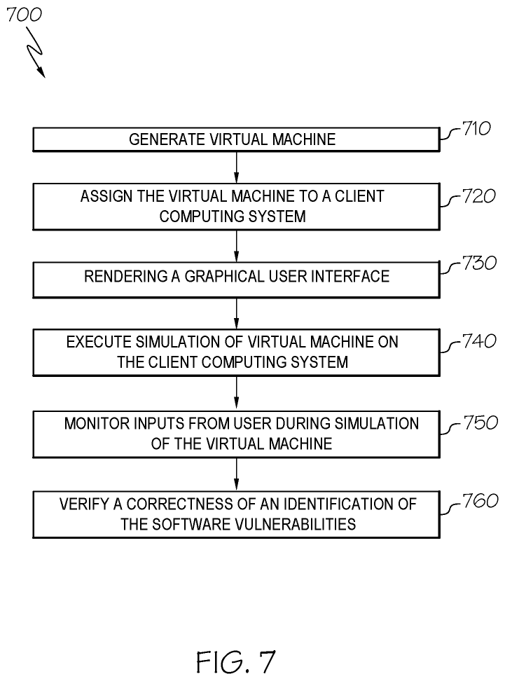

Referring to FIG. 7, an illustrative flow diagram 700 of a method for providing a virtual machine implementing software vulnerabilities to train users and/or computer systems to detect and address the software vulnerabilities according to one or more embodiments shown and described herein. It should be understood that the blocks of the present flow diagram may be executed by one or more elements of the system 10 described herein. For purposes of explanation, but without limitation, the method depicted by the flow diagram 700 will be described with reference to the administrative computing system 20 and the client computing systems 30. In some embodiments, the orchestration engine 22 may be a computer program product and/or a machine-readable instruction set configured execute the processes depicted by the method blocks of the flow diagram 700. At block 710, the administrative computing system 20 generates virtual machines having varying parameters and varying software vulnerabilities. Accordingly, the administrative computing system 20 may provide each client computing device 30 with one or more differing virtual machines having differing software vulnerabilities. At block 720, the administrative computing system 20 assigns the generated virtual machines for simulation one or more of the client computing systems 30. As a non-limiting example an administrator 40 may assign each of the users 50 to a particular client computing system 30, dynamically define software vulnerabilities to be include within the virtual machines, and define a length of the simulation session.

At block 730, one or more graphical user interfaces are rendered for display on display devices of the client computing systems. The rendered graphical user interfaces allow a user 50 to request generation of a virtual machine for a simulation session. When a user 50 is ready to begin a simulation session, the user may select an activation tool 206 to begin training of the user (or the client computing system itself in embodiments where the client computing system is being trained). The graphical user interfaces can display parameters of the virtual machine. The graphical user interfaces may further provide interface tools to receive input from users during simulation of virtual machines. At block 740, a simulation of the virtual machine on the client computing system is executed. Execution of the simulation of the virtual machine may include providing various user interfaces to the user or causing the client computing system to automatically respond to the prompts through the implementation and training of an artificial intelligence model. At block 750, the administrative computing system 20 monitors activity on the client computing system 30 which includes inputs provided by the user or automated responses from the artificial intelligence model. In some embodiments, the administrative computing system 20 may monitor the client computing system 30, track user progress, track results of identifications, and provide administrators with reports regarding a client computing system. At block 760, the administrative computing system 20 and/or the client computing system 30 is configured to verify the correctness of the identification of the software vulnerabilities. In some embodiments, the verification process may include checking syntax responses and/or matching selections. Upon completion of or during a simulation or testing session, the administrative computing system 20 may generate and report a score for each client computing system 30 of the plurality of client computing systems 30. Subsequently, the administrative computing system 20 may rank and generate a report indicating the ranking of each client computing system 30 of the client computing systems 30.

The functional blocks and/or flowchart elements described herein may be translated into machine-readable instructions. As non-limiting examples, the machine-readable instructions may be written using any programming protocol, such as: descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

It is noted that various modifications and variations can be made without departing from the scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

1. A method for providing dynamic virtual machines, the method comprising:
generating a virtual machine implementing one or more software vulnerabilities;
assigning the virtual machine to a client computing system;
rendering a graphical user interface for display on a display device of the client computing system, wherein the graphical user interface is configured to display parameters of the virtual machine and interface tools to receive input from a user during simulation of the virtual machine;
monitoring inputs from the user during the simulation of the virtual machine on the client computing system; and
in response to monitoring the inputs from the user, verifying a correctness of an identification of the one or more software vulnerabilities from the inputs.

2. The method of claim 1, further comprising selecting parameters for the virtual machine from a database.

3. The method of claim 2, wherein the parameters comprise at least one of a computing address, a port configuration, a memory requirement, and/or a CPU requirement of the virtual machine.

4. The method of claim 1, wherein the interface tools comprise at least one of buttons, drop down menus, and/or text boxes configured to enable the user to build a solution indicating the identification of the one or more software vulnerabilities of the virtual machine.

5. The method of claim 1, further comprising generating a score for the client computing system implementing the virtual machine, wherein the score increases in response to correct identification of the one or more software vulnerabilities.

6. The method of claim 1, wherein the one or more software vulnerabilities comprise at least one of an error, a flaw, a fault, and/or a vulnerability that is associated with at least one of an application service and/or a network of the virtual machine.

7. The method of claim 1, wherein a predetermined token is located in a virtual memory unit of the virtual machine that identifies a software vulnerability of the one or more software vulnerabilities.

8. The method of claim 7, wherein verifying the correctness of the identification of the one or more software vulnerabilities from the inputs includes comparing a token received as an input from the user to the predetermined token.

9. The method of claim 1, further comprising:
generating a second virtual machine implementing one or more second software vulnerabilities different from the one or more software vulnerabilities;
assigning the second virtual machine to a second client computing system;
rendering a second graphical user interface for display on a display device of the second client computing system, wherein the second graphical user interface is configured to display parameters of the second virtual machine and interface tools to receive input from a second user during simulation of the second virtual machine;
monitoring inputs from the second user during the simulation of the second virtual machine on the second client computing system; and
in response to monitoring the inputs from the second user, verifying a correctness of an identification of the one or more second software vulnerabilities from the inputs.

10. The method of claim 1, further comprising:
rendering a second graphical user interface for display on the display device of the client computing system, wherein the second graphical user interface comprises a dynamically built syntax problem based on a software tool or a programing language and an interface prompting the user to enter proper syntax in response to the dynamically built syntax problem.

11. The method of claim 1, further comprising:
rendering a third graphical user interface for display on the display device of the client computing system, wherein the third graphical user interface comprises a plurality of columns, wherein a first column includes a plurality of different protocols and a second column includes a plurality of different ports, each of the plurality of different protocols are correlated to one or more of the plurality of different ports,
prompting the user to select matches between the plurality of different ports and the plurality of different protocols, and
verifying the selected matches to determine whether the user has provided correct matches.

12. A system for providing dynamic virtual machines, the system comprising:
an administrative computing device comprising a processor, and a non-transitory computer-readable medium; and
a machine-readable instruction set stored in the non-transitory computer readable memory of the administrative computing device that causes the system to perform at least the following when executed by the processor:
generate a virtual machine implementing one or more software vulnerabilities,
assign the virtual machine to a client computing system,
render a graphical user interface for display on a display device of the client computing system, wherein the graphical user interface is configured to display parameters of the virtual machine and interface tools to receive input from a user during simulation of the virtual machine,
monitor inputs from the user during the simulation of the virtual machine on the client computing system, and
in response to monitoring the inputs from the user, verify a correctness of an identification of the one or more software vulnerabilities from the inputs.

13. The system of claim 12, wherein the machine-readable instruction set, when executed by the processor, further causes the system to select parameters for the virtual machine from a database.

14. The system of claim 13, wherein the parameters comprise at least one of a computing address, a port configuration, a memory requirement, and/or a CPU requirement of the virtual machine.

15. The system of claim 12, wherein interface tools comprise at least one of buttons, drop down menus, and/or text boxes configured to enable the user to build a solution indicating the identification of the one or more software vulnerabilities of the virtual machine.

16. The system of claim 12, wherein the machine-readable instruction set, when executed by the processor, further causes the system to generate a score for the client computing system implementing the virtual machine, wherein the score increases in response to correct identification of the one or more software vulnerabilities.

17. The system of claim 12, wherein the one or more software vulnerabilities comprise at least one of an error, a flaw, a fault, and/or a vulnerability that is associated with at least one of an application service and/or a network of the virtual machine.

18. The system of claim 12, wherein a predetermined token is located in a virtual memory unit of the virtual machine that identifies a software vulnerability of the one or more software vulnerabilities, and
verification of the correctness of the identification of the one or more software vulnerabilities from the inputs includes comparing a token received as an input from the user to the predetermined token.

19. A computer program for providing dynamic virtual machines comprising instructions which, when the computer program is executed by a computer, cause the computer to carry out steps comprising:
generating a virtual machine implementing one or more software vulnerabilities;
assigning the virtual machine to a client computing system;
rendering a graphical user interface for display on a display device of the client computing system, wherein the graphical user interface is configured to display parameters of the virtual machine and interface tools to receive input from a user during simulation of the virtual machine;
monitoring inputs from the user during the simulation of the virtual machine on the client computing system; and
in response to monitoring the inputs from the user, verifying a correctness of an identification of the one or more software vulnerabilities from the inputs.

20. The computer program of claim 19, further comprising instructions which, when the computer program is executed by the computer, cause the computer to carry out steps comprising:
generating a score for the client computing system implementing the virtual machine, wherein the score increases in response to correct identification of the one or more software vulnerabilities.
